(19) United States
(12) Patent Application Publication
(10) Pub. No.: US 2006/0183444 A1
(43) Pub. Date: Aug. 17, 2006

(54) Capacitance compensation type directional coupler and IPD for multi-band having the same

(75) Inventors: Dae Heon Hur, Suwon (KR); Ki Joong Kim, Iksan (KR); Young Hoon Kim, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/326,333

(22) Filed: Jan. 6, 2006

(30) Foreign Application Priority Data
Feb. 14, 2005 (KR) 10-2005-0012031

(51) Int. Cl. H01Q 11/12; H04B 1/04

(52) U.S. Cl. 455/126; 455/127.1

(57) ABSTRACT

The present invention relates to a directional coupler, in particular, to a capacitance compensation type directional coupler comprising a signal line for transmitting signals. A coupling line is formed apart from and parallel to the signal line, with its first end transmitting the extracted power and its second end terminated. At least one conductive line, electrically connected to the coupling line, is extended from the coupling line across the signal line, apart from and perpendicularly overlapping with the signal line. The present invention compensates capacitance between the signal line and the coupling line by forming capacitance in areas where the conductive line and the signal line overlapping each other perpendicularly.

### CLAIM OF PRIORITY

This application claims the benefit of Korean Patent Application No. 2005-12031 filed on Feb. 14, 2005, in the Korean Intellectual Property Office, the disclosure of which is incorporated herein by reference.

### BACKGROUND OF THE INVENTION

1. Field of the Invention

The present invention relates to a directional coupler, and more particularly, to a capacitance compensation type directional coupler and a multi-band Integrated Passive Device (IPD) having a capacitance compensation type directional coupler which easily forms capacitance to improve directionality between a signal line and a coupling line, and does not adopt a separate capacitor to form capacitance, thereby realizing compact size in an IPD.

2. Description of the Related Art

In general, a directional coupler is an electric device used in extracting and distributing electric power. More specifically, a directional coupler is used to partially extract electric power from sending signals being transmitted through the signal line in order to control gains of a power amplifier which amplifies the sending signals that are sent through the signal line in wireless telecommunication terminals.

FIG. 1 is an overall block diagram of a sending-receiving circuit of a wireless telecommunication terminal with a directional coupler. Particularly, FIG. 1 illustrates a multi-band sending-receiving circuit of a wireless telecommunication terminal which allows taking advantage of wireless telecommunication service in two or more frequency bands. As shown in FIG. 1, a signal received by an antenna is outputted according to its frequency band by an RF switch 11. Then, the signal passes through a filter/matching circuit 12 and is converted into a base-band signal in an RF transceiver 13. The converted base-band signal is processed at a base-band processor 14 and received ultimately by the user. In addition, the above RF transceiver 13 receives a base-band signal from the base-band processor 14 and converts it into an RF signal which is then outputted according to its frequency band. Each signal outputted from the RF transceiver 13 is amplified at a power amplifier 15a or 15b into a certain amount of gains, which then passes through an RF switch and is sent outside through the antenna.

In the above sending-receiving process of a wireless telecommunication terminal, power amplifiers 15a, 15b should amplify sending signals into gains appropriate for sending. In order to appropriately control the gains of the power amplifiers 15a and 15b, electric power is partially extracted from the signals amplified at the power amplifiers. With this extracted power, addition or subtraction of the gains is controlled. Therefore, in order to control the gains of the power amplifiers 15a, 15b by partially extracting electric power from the sending signals, a directional coupler having coupling lines 16a, 16b is utilized in the sending line.

The above directional coupler partially extracts the electric power from the sending signals transmitted via the sending line, at the coupling lines 16a and 16b, and transmits the extracted power through a duplexer 17 to a gain controller 18. The gain controller 18 appropriately controls the gains of the power amplifiers 16a and 16b according to the magnitude of the extracted electric power. The duplexer 17 has a function of transmitting the electric power to the gain controller 18 while preventing the power extracted from one signal line from propagating to the other signal line.

In the above described sending-receiving circuit of a wireless telecommunication terminal, the directional coupler and the duplexer 17 may be manufactured in a form of IPD. This IPD involves a technique for manufacturing a circuit in a chip form by accumulating a plurality of passive devices using semiconductor Integrated Circuit (IC) process in general. Since this technique has merits of being able to reduce the size of the mounting area compared with the method of mounting individual device, and to decrease error rate in the process, it is actively utilized in the field of the wireless telecommunication terminals in which light weight and compact size is required. FIG. 2 illustrates an example in which the part indicated by ‘A’ of FIG. 1 is manufactured in a form of IPD.

With reference to FIG. 2, a prior art IPD coupler includes: signal lines 21a and 21b transmitting sending signals; coupling lines 200a and 200b disposed parallel to and apart in a predetermined interval from the signal lines 21a and 21b; compensation capacitors 23a and 23b forming capacitance between the first end of the coupling lines 200a and 200b and the signal lines 21a and 21b. FIG. 2 illustrates a coupler that may be used in a multi-band wireless telecommunication terminal shown in FIG. 1. In a multi-band wireless telecommunication terminal, two signal lines 21a and 21b and two coupling lines 200a and 200b are formed respectively, and the signal and coupling line pairs are sorted into high frequency and low frequency.

The above signal lines 21a and 21b transmit sendng signals which were amplified into a certain amount of gains by the power amplifiers 15a and 15b (FIG. 1) of the wireless telecommunication terminal to the antenna. The coupling lines 200a and 200b are disposed parallel to and apart in a set interval from the signal lines 21a and 21b, forming couplers with the signal lines 21a and 21b respectively. The coupling lines 200a and 200b partially extract electric power from the sending signals transmitted to the signal lines 21a and 21b. The electric power partially extracted from the coupling lines 200a and 200b is transmitted to the gain controller 18 of FIG. 1 through the duplexer 17, and according to this transmitted power, the gain controller 18 of FIG. 1 controls the gains of the power amplifiers.

The above coupling lines 200a and 200b partially extract electric power from the sending signals transmitted through the signal lines 21a and 21b. At this time, a very small amount of electric power should be extracted so as not to affect the sending signals. Therefore, the length of the coupling lines 200a and 200b is formed short in order to extract a minimal amount of electric power needed for the power amplifiers to control the gains: the shorter the length of the coupling lines 200a and 200b, the weaker the directionality of the coupler. That is, the power extracted from the coupling lines 200a and 200b may not be transmitted to the duplexer 17 but may be transmitted to the terminated ends 22a and 22b of the coupling lines 200a and 200b. In order to solve such a shortcoming of weak directionality in the prior art, interdigital compensation capacitors 23a and 23b were installed to form capacitance between the signal lines 21a and 21b and the coupling lines 200a and 200b.

However, as shown in FIG. 2, since the prior art capacitors 23a and 23b are interdigital, they are very complicated to design, and they take up a large space in IPD, hindering size reduction of IPD.

### SUMMARY OF THE INVENTION

The present invention has been made to solve the foregoing problems of the prior art and it is therefore an object of the present invention to provide a capacitance compensation type directional coupler electrically connected to a coupling line, forming a conductive line perpendicularly overlapping with the signal line to form capacitance between the signal line and the conductive line, thereby compensating capacitance between the coupling line and the signal line.

It is another object of the present invention to provide a multi-band IPD having the above capacitance compensation directional coupler.

In order to realize the above described objects, the present invention provides a capacitance compensation type directional coupler comprising: a signal line for transmitting signals; a coupling line formed parallel to and apart from the signal line to partially extract electric power from the signals transmitted through the signal line, and with a first end transmitting the extracted power, and a second end terminated; and at least one conductive line electrically connected to the coupling line and extended from the coupling line across the signal line, apart from and perpendicularly overlapping with the signal line, whereby capacitance is formed between areas of the conductive line and the signal line perpendicularly overlapping each other, and which compensates capacitance between the signal line and the coupling line.

In a preferred embodiment of the present invention, at least one conductive line mentioned above may be electrically connected to the first end of the coupling line which transmits the extracted electric power, extended from the coupling line across the signal line, apart from and perpendicularly overlapping with the signal line, and via which the electric power extracted from the coupling line may be transmitted.

Moreover, in a preferred embodiment of the present invention, at least one conductive line described above may be electrically connected to the second end of the coupling line to transmit the extracted electric power, extended from the coupling line across the signal line, apart from and perpendicularly overlapping with the signal line, with its second end terminated.

In addition, at least one conductive line described above, by changing the width and modifying the size of the area overlapping with the signal line, may adjust the magnitude of capacitance between the signal line and the coupling line.

In addition, the present invention provides a multi-band IPD having the above coupler. The multi-band IPD in a multi-band telecommunication terminal for partially extracting the electric power from the multi-band sending signals amplified by a power amplifier, and the IPD providing the extracted power to a gain controller which controls the gains of the power amplifier comprising:

a first input end for receiving at least one first sending signal having a central frequency and a second input end for receiving at least one second sending signal having a central frequency other than that of the first sending signal;

first and second signal lines for transmitting the first sending signal and second sending signals received from the first and second input ends respectively;

a first and second output ends for outputting the first and second sending signals transmitted from the first and second signal lines, respectively;

a first coupling line formed parallel to and apart in a predetermined interval from the first signal line, with a first end transmitting the extracted power, and a second end terminated to partially extract electric power from the first sending signal transmitted through the first signal line;

a first conductive line electrically connected to the first end of the first coupling line to transmits the power extracted from the first coupling line, the first conductive line extended from the first coupling line across the first signal line, apart from and perpendicularly overlapping with the first signal line;

a second coupling line formed parallel to and apart in a predetermined interval from the second signal line, with a first end transmitting the extracted power and a second end terminated to partially extract electric power from the second sending signal transmitted from the second signal line;

a second conductive line electrically connected to the first end of the second coupling line to transmits the power extracted from the second coupling line, the second conductive line extended from the second coupling line across the second signal line, apart from and perpendicularly overlapping with the second signal line;

a duplexer for separating the power transmitted from the first and second conductive lines respectively; and

a third output end for outputting the power separated by the duplexer, and connected to the gain controller, and

capacitance is formed between areas of the first and the second conductive lines and of the first and the second signal lines perpendicularly overlapping each other, respectively, to compensate capacitance formed between the first and the second signal lines and between the first and the second coupling lines, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an overall block diagram illustrating a sending-receiving circuit of a wireless telecommunication terminal having a directional coupler;

FIG. 2 illustrates an example of the prior art in which ‘A’ of FIG. 1 was manufactured in an IPD form;

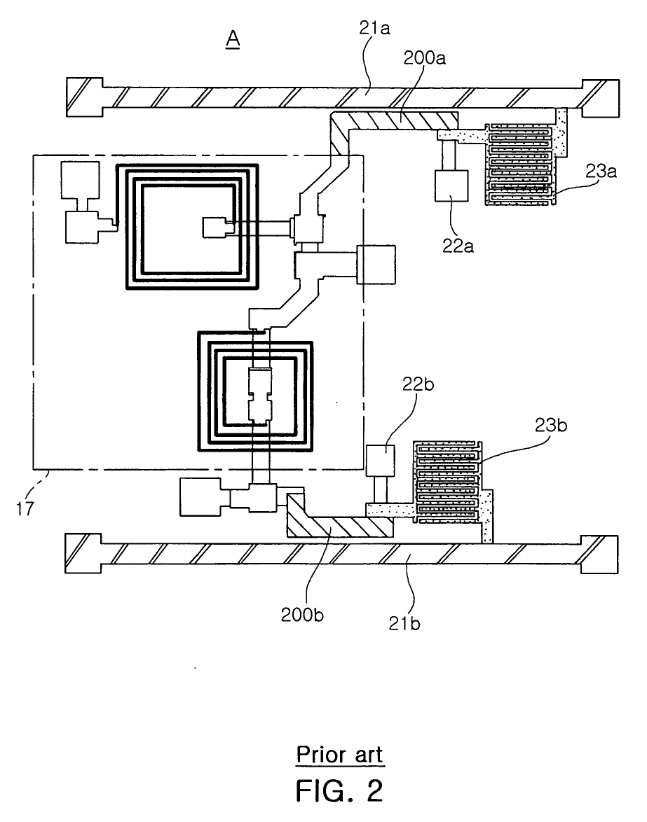

FIG. 3 illustrates an IPD having a directional coupler according to the present invention; and

FIG. 4 is a sectional view illustrating a partial section, cut along the line I-I′ of FIG. 3, of a directional coupler according to the present invention.

### DETAILED DESCRIPTION OF THE PREFERRED EMBODIMENT

The following description will present a capacitance compensation type directional coupler and a multi-band IPD having the same of the invention with reference to the accompanying drawings. The same reference numerals are used to designate components with essentially identical compositions and functions.

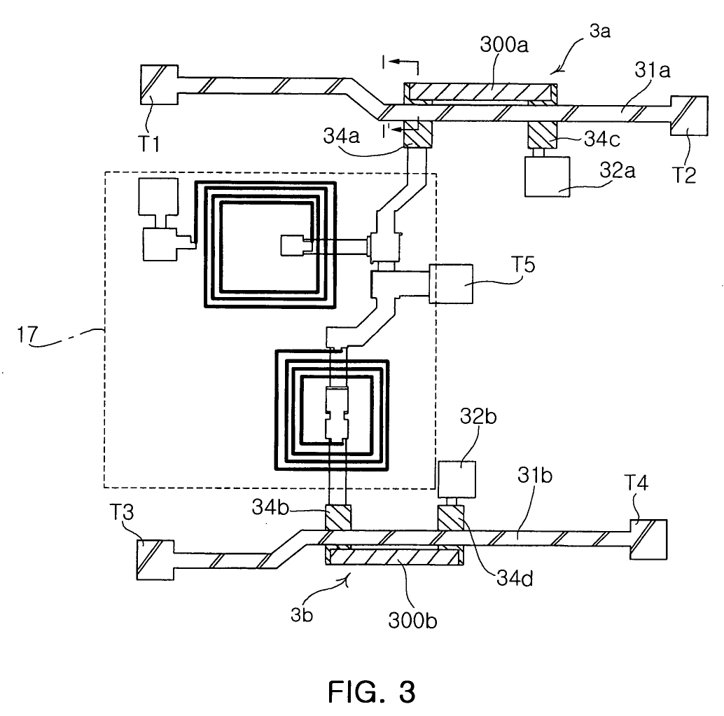

FIG. 3 illustrates an IPD having a directional coupler according to a first embodiment of the present invention. With reference to FIG. 3, each of directional couplers 3a and 3b according to the first embodiment includes: a signal line 31a, 31b; a coupling line 300a, 300b formed parallel to and apart in a predetermined interval from the signal line 31a, 31b to extract electric power from the signal transmitted through the signal line, with its first end to transmit the extracted power and its second end terminated; and a plurality of conductive lines 34a, 34b; 34c, 34d electrically connected to the coupling line 300a, 300b, and extended from the coupling lines across the signal line 31a, 31b, apart from and perpendicularly overlapping with the signal line. FIG. 3 illustrates an IPD which may be used in a multi-band wireless telecommunication terminal in which a plurality of frequency bands are sorted into high frequency and low frequency and transmitted through two signal lines.

The signal line 31a, 31b is a line through which the signal desired to be sent is transmitted in a sending-receiving circuit of a wireless telecommunication terminal.

The coupling line 300a, 300b is formed apart from in a set interval and parallel to the signal line 31a, 31b to partially extract power from the signal transmitted through the signal line 31a, 31b, thereby producing coupling with the signal line 31a, 31b. The first end of the coupling line 300a, 300b transmits the power extracted by coupling, and the second end is terminated by a termination resistor 32a, 32b having a resistance of 50 Ω. The first and second ends of the coupling line 300a, 300b may be electrically connected to the conductive lines 34a, 34b; 34c, 34d having a predetermined width.

The conductive line 34a, 34b is electrically connected to the coupling line 300a, 300b, and extended from the coupling line 300a, 300b across the signal line 31a, 31b, apart from and perpendicularly overlapping with the signal line 31a, 31b. In this embodiment, the conductive lines 34a, 34b; 34c, 34d include the conductive line 34a, 34b connected to the first end of the coupling line 300a, 300b where the electric power is transmitted, and the conductive line 34c, 34d connected to the second end of the coupling line 300a, 300b which is terminated.

The connection structure of the conductive lines 34a, 34b; 34c, 34d proposed in this embodiment shown in FIG. 3 does not limit the present invention; the present invention includes all conductive lines that have a structure of being electrically connected to the coupling line 300a, 300b, and extended from the coupling lines 300a, 300b across the signal line 31a, 31b, apart from and perpendicularly overlapping with the signal line 31a, 31b.

In this embodiment, the power extracted from the coupling line 300a, 300b is transmitted through the conductive line 34a, 34b which is connected to the first end of the coupling line 300a, 300b for transmitting electric power. In the IPD illustrated in FIG. 3, the conductive line 34a, 34b is connected to the first end of the coupling line 300a, 300b where transmission of electric power occurs, and transmits the extracted power to the duplexer 17.

In addition, in this embodiment, the conductive lines 34c, 34d is electrically connected to the second end of the coupling line 300a, 300b which transmits the extracted power, its first end may be electrically connected to the coupling line 300a, 300b, and its second end may be terminated at the termination resistor that has a resistance of 50 Ω.

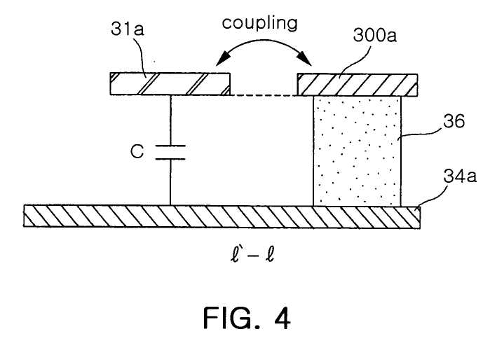

In such a structure of the coupler 3a, 3b, by forming capacitance in the areas where the conductive lines 34a, 34b; 34c, 34d perpendicularly overlap with the signal line 31a, 31b, capacitance between the signal line 31a, 31b and the coupling line 300a, 300b is compensated. Such characteristics of the present invention will be clearer with the explanation with reference to FIG. 4.

FIG. 4 is a sectional view showing a partial section, cut along the line I-I′ of FIG. 3, of the directional coupler shown in the present invention. In general, an IPD has a wiring substrate structure having multiple insulating layers and conductive patterns alternating with these insulating layers. The conductive patterns formed on different levels may be electrically connected to each other by a conductive via, etc. formed through the insulating layers. Considering such structure of the IPD shown in FIG. 4, in the coupler 3a (FIG. 3) according to the present invention, the coupling line 300a is disposed parallel to the signal line 31a to partially extract electric power from the signal being transmitted to the signal line 31a, at the coupling line 300a. It is desirable that the signal line 31a and the coupling line 300a are formed on the same level in the IPD. The conductive line 34a of the coupler according to the present invention is formed on a different level from the signal line 31a and the coupling line 300a. The purpose of this is to allow the conductive line 34a and the signal line 31a to be apart from each other in a set interval and have an area where they overlap each other to form capacitance C between the conductive line 34a and the signal line 31a. The conductive line 34a is electrically connected to the coupling line 300a. Such electric connection is made possible by conductive via 36 extended from the conductive line 34a to the coupling line 300a.

In other words, since the conductive line 34a and the coupling line 300a are electrically connected, and capacitance C is formed between the conductive line 34a and the signal line 31a, capacitance C is also induced between the coupling line 300a and the signal line 31a. As a result, in the present invention, capacitance between the coupling line 300a and the signal line 31a is formed in a quite simple structure, improving the directionality of the coupler. In addition, since there is no need to form a separate capacitor, size reduction of the IPD is possible. Moreover, the magnitude of the capacitance may be easily adjusted since the size of the area of the area where the conductive line 34a overlaps with the signal line 31a can be easily adjusted by changing the width of the conductive line 34a.

At the same time, the present invention provides a multi-band IPD having a coupler according to the above described invention. The multi-band IPD is a device used for partially extracting electric power from the multi-band sending signals amplified by the power amplifier, and providing the extracted power to the gain controller which controls the gains of the power amplifier.

With reference to FIG. 3, an IPD in a multi-band wireless telecommunication terminal for partially extracting electric power from sending signals amplified by a power amplifier, and the IPD providing the extracted power to a gain controller which controls gains of the power amplifier includes: a first input end T1 for receiving at least one first sending signal having a central frequency, a second input end T3 for receiving at least one second sending signal having a central frequency other than that of the first sending signal; first and second signal lines 31a and 31b for transmitting the first and second sending signals inputted from the first and the second input ends T1 and T3 respectively; a first and second output ends T2 and T4 for outputting the first and second sending signals transmitted from the first and second signal lines 31a and 31b, respectively; a first coupling line 300a formed parallel to and apart in a predetermined interval from the first signal line 31a, with a first end transmitting the extracted power and a second end terminated to partially extract electric power from the first sending signal transmitted through the first signal line 31a; a first conductive line 34a electrically connected to the first end of the coupling line 300a to transmit the power extracted from the first coupling line 300a, the first conductive line extended from the first coupling line 300a across the first signal line 31a, apart from and perpendicularly overlapping with the first signal line 31a; a second coupling line 300b formed parallel to and apart in a predetermined interval from the second signal line 31b, with a first end transmitting the extracted power and a second end terminated to partially extract electric power from the second sending signals transmitted through the second signal line; a second conductive line 34b electrically connected to the first end of the second coupling line 300b to transmit the power extracted from the second coupling line 300b, the second conductive line extended from the second coupling line 300b across the second signal line 31b, apart from and perpendicularly overlapping with the second signal line 31b; and a duplexer 17 for separating the power transmitted from the first and second conductive lines 34a and 34b; and a third output end T5 for outputting the power separated by the duplexer, and connected to the gain controller.

In an IPD according to the present invention, the first signal line 31a, the first coupling line 300a, and the first conductive line 34a constitute the first coupler 3a while the second signal line 31b, the second coupling line 300b, and the second conductive line 34b constitute a second coupler 3b.

The couplers 3a and 3b may further include a third conductive line 34c and a fourth conductive line 34d respectively. The third conductive line 34c is electrically connected to the second end of the first second coupling line 300a transmitting the extracted power, extended from the first coupling line 300a across the first signal line 31a, apart from and perpendicularly overlapping with the first signal line 31a, and its second end is terminated at the termination resistor 32a having a resistance of 50 Ω.

The fourth conductive line 34d is connected to the second end of the second coupling line 300b in the same fashion as the third conductive line 34c.

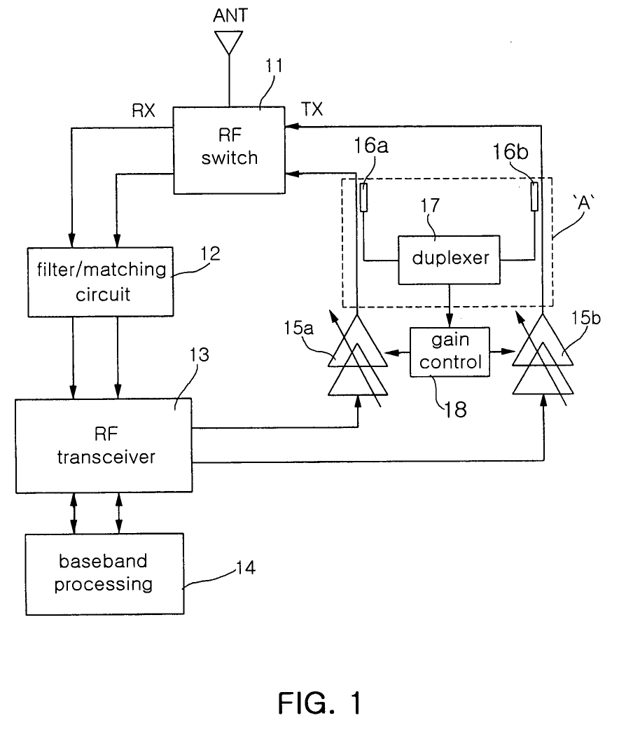

The duplexer 17 prevents the power extracted from the first coupler 3a from being transmitting to the second coupler 3b, and also prevents the power extracted from the second coupler 3b from being transmitted to the first coupler 3a. The extracted power separated by the duplexer 17 is outputted through the third output end T5. In the case of an IPD of the present invention used in a wireless telecommunication terminal, the extracted power outputted from the third output end is transmitted to the gain controller 18 (FIG. 1) which controls the gains of the power amplifiers 15a and 15b (FIG. 1).

As set forth above, according to the present invention, in a simple structure of forming a conductive line electrically connected to the coupling line and overlapping perpendicularly with the signal line, capacitance is formed between the signal line and the conductive line, thereby resulting in an effect of improving the directionality of the coupler.

In addition, the width of the conductive line perpendicularly overlapping with the signal line can be modified, resulting in an effect of easy adjustment of capacitance formed between the signal line and the conductive line by modifying.

Furthermore, as there is no need to form a separate capacitor between the signal line and the coupling line, size reduction of IPD is possible.

While the present invention has been shown and described in connection with the preferred embodiments, it will be apparent to those skilled in the art that modifications and variations can be made without departing from the spirit and scope of the invention as defined by the appended claims.

What is claimed is:

1. A capacitance compensation type directional coupler comprising:
a signal line for transmitting signals;
a coupling line provided to partially extract electric power from the signals transmitted through the signal line, the coupling line formed parallel to and apart in a predetermined interval from the signal line, with a first end transmitting the extracted power and a second end terminated; and
at least one conductive line electrically connected to the coupling line, and extended from the coupling line across the signal line, apart from and perpendicularly overlapping with the signal line, whereby capacitance is formed between the areas of the conductive line and the signal line overlapping each other perpendicularly to compensate capacitance between the signal line and the coupling line.

2. The capacitance compensation type directional coupler according to claim 1, wherein the at least one conductive line is electrically connected to the first end of the coupling line to transmit the power extracted from the coupling line through its second end.

3. The capacitance compensation type directional coupler according to claim 1, wherein the at least one conductive line is electrically connected to the second end of the coupling line, and an end terminated.

4. The capacitance compensation type directional coupler according to claim 1, wherein the at least one conductive line is changed in its width and modified in the size of the area overlapping with the signal line to adjust the magnitude of the capacitance between the signal line and the coupling line.

5. A multi-band Integrated Passive Device (IPD) in a multi-band wireless telecommunication terminal for partially extracting electric power from sending signals amplified by a power amplifier, and providing the extracted power to a gain controller which controls gains of the power amplifier, the IPD comprising:
a first input end for receiving at least one first sending signal having a central frequency; a second input end for receiving at least one second sending signal having a central frequency other than that of the first sending signal;
first and second signal lines for transmitting the first and second sending signals received at the first and second input ends respectively;
first and second output ends for outputting the first and second sending signals transmitted from the first and second signal lines, respectively;
a first coupling line formed parallel to and apart in a predetermined interval from the first signal line, with a first end transmitting the extracted power and a second end terminated to partially extract electric power from the first sending signal transmitted through the first signal line;
a first conductive line electrically connected to the first end of the first coupling line to transmit the power extracted from the first coupling line, the first conductive line extended from the first coupling line across the first signal line, apart from and perpendicularly overlapping with the first signal line;
a second coupling line formed parallel to and apart in a predetermined interval from the second signal line, with a first end transmitting the extracted power and a second end terminated to partially extract electric power from the second sending signal transmitted through the second signal line;
a second conductive line electrically connected to the first end of the second coupling line to transmit the extracted power from the second coupling line, extended from the second coupling line across the second signal line, apart from and perpendicularly overlapping with the second signal line;
a duplexer for separating power transmitted from the first and second conductive lines; and
a third output end for outputting the power separated by the duplexer, and connected to the gain controller, and
whereby capacitance is formed between the areas of the first and second conductive lines and of the first and second signal lines perpendicularly overlapping each other, respectively, to compensate capacitance between the first and second signal lines, and between the first and the second coupling lines, respectively.

6. The multi-band IPD according to claim 5, further comprising third and fourth conductive lines with first ends electrically connected to the second ends of the first and second coupling lines respectively, and second ends terminated, the third conductive line extended from the first coupling line across the first signal line, apart from and perpendicularly overlapping with the first signal line, and the fourth conductive line extended from the second coupling line across the second signal line, apart from and perpendicularly overlapping with the second signal line.

7. The multi-band IPD according to claim 5, wherein the first and second conductive lines are changed in their widths and modified in the size of the areas overlapping with the first and second signal lines, respectively, to adjust the magnitude of the capacitance formed between the first and second signal lines, and between the first and the second coupling lines, respectively.

8. The multi-band IPD according to claim 6, wherein the third and the fourth conductive lines are changed in their widths and modified in the size of the areas overlapping with the first and the second signal lines, respectively, to adjust the magnitude of the capacitance formed between the first and the second signal lines, and between the first and the second coupling lines, respectively.
